(19) United States
(12) Patent Application Publication
(10) Pub. No.: US 2010/0332302 A1
(43) Pub. Date: Dec. 30, 2010

(54) SYSTEMS AND METHODS FOR INTERACTIVE ON-LINE ADVERTISING USING AUCTION PRIZES AWARDED BASED ON USER ENGAGEMENT AS DETERMINED BY AD-SURVEY SUBMISSION

(75) Inventors: Gal ROTEM, Petah Tikva (IL); Dror Orbach, Bnel Ayish (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ADABRA Ltd., Tel Aviv (IL)

(21) Appl. No.: 12/490,351

(22) Filed: Jun. 24, 2009

(51) Int. Cl. G06Q 30/00

(52) U.S. Cl. 705/14.14; 705/14.19; 705/14.25; 705/14.49; 705/14.1; 705/14.73; 705/14.39; 705/14.2; 705/14.71

(57) ABSTRACT

The present invention discloses systems and methods for interactive on-line advertising using auction prizes awarded based on user engagement as determined by ad-survey submission, methods including the steps of: providing an ad survey having an advertisement and a survey for viewing and submission; upon a user submitting a completed ad survey, presenting the user with an incentive to be pledged, by the user, to an ad-survey auction; and awarding an auction prize to a wining user based on a maximum amount of pledged incentive in the ad-survey auction by the winning user. Preferably, the method further includes the step of: constructing a user profile having at least one user characteristic for users of the ad survey. Most preferably, at least one user characteristic is selected from the group consisting of: a user surfing pattern, publicly-available user data, private user data, a user interest, and an ad-survey interest.

### FIELD AND BACKGROUND OF THE INVENTION

The present invention relates to systems and methods for interactive on-line advertising using auction prizes awarded based on user engagement as determined by ad-survey submission.

Retailers and product manufacturers are always looking for new marketing channels for their products. Providing an incentive to purchase from a retailer and/or retail merchants has been a well-used marketing tool. Typically, merchants provide non-monetary incentives or monetary credits toward future purchases. Such incentives include: coupons, mileage awards, discounts, redemption awards, and cash-back awards. In addition, this serves as advertisement for a product, service, or manufacturer, which encourages use of a specific brand or product.

The advent of the Internet has enabled consumers to expand their options in selecting and purchasing products, making market competition for retail merchants even more aggressive. On-line advertising has shown huge growth. The on-line and mobile advertising markets are expected to continue to grow rapidly during the next several years.

The “novelty” factor of traditional Internet advertising has been shown to fade over time as web surfers gradually become “blind” to common advertising formats. Business models based on “page views” are being replaced with models based on actual clicks into an ad to better reflect the value to the advertiser. Ad networks (i.e. companies that connect websites that want to host advertisements with advertisers who want to run advertisements) are constantly looking for ways to innovate and differentiate, yet most support a small number of mostly-intrusive ad formats. Intrusive ads have become an irritation to surfers and mobile users, reducing their effectiveness as sales and brand enhancement tools.

Various on-line advertising methods exist in the prior art. Eldering, in U.S. Pat. No. 6,324,519, teaches an advertisement auction system in which content/opportunity providers announce to advertisers that they have an opportunity to present an advertisement to a consumer. The advertiser transmits ad characterization information which is correlated with the consumer profile. Based on the results of the correlation, the advertisers place bids for the advertisement opportunity. Upon acceptance of a bid, the advertisement is delivered to the consumer.

Joao, in US Patent Publication No. 20010056374, discloses an apparatus for providing compensation for viewing and/or for participating in an advertisement, a survey, a poll, or a questionnaire, including a receiver for receiving a request to obtain information regarding at least one of a good, a product, and a service, a memory device for storing information.

Arkes, in US Patent Publication No. 20070118461, discloses an incentives points-based on-line auction method that is based upon an on-line system including a catalog of potential auction items and a database of participants that are eligible to take part in the auction and the participants' associated eligible points. The method includes designating a set of auction items from the catalog of potential auction items. Thereafter, participants submit bids via on-line access for the set of auction items. In response, to receiving a bid from a participant, the auction facilities determine whether the participant has sufficient points in a point bank to submit the bid.

Hughes et al., in US Patent Publication No. 20070226062, disclose providing infrastructure, process controls, and software to design, advertise, and implement an on-line contest in which participants in the contest search the Internet for a target in order to earn a reward. Hints and/or hidden objects may provide clues as to where to look for the reward, how to claim the reward, and what the reward is. The reward is funded by participating web site owners who reserve, in some embodiments via an auction, the opportunity to “host” the target during a contest or a portion of a contest, and as a result, drive traffic to their respective web sites.

Dennison et al., in US Patent Publication No. 20080082397, disclose systems for targeting marketing to a user of a web site, providing advertisements to a consumer relating to various goods and/or services, and associating advertisements with a voucher. A point assignment system is configured to assign points to categories based on a user's navigation, and wherein the assigned points indicate a user's interest in one or more goods and/or services associated with a category.

Santa Ana, in US Patent Publication No. 20080082408, discloses a system or method related to a cash award directly awarded to users of products and services, based on purchase, use, or other activities. It also relates to the cash award for viewing ads, based on click or other metrics.

It would be desirable to have systems and methods for interactive on-line advertising using auction prizes awarded based on user engagement as determined by ad-survey submission. Such methods would, inter alia, overcome the limitations of the prior art mentioned above.

### SUMMARY OF THE INVENTION

It is the purpose of the present invention to provide systems and methods for interactive on-line advertising using auction prizes awarded based on user engagement as determined by ad-survey submission.

In the interest of clarity, several terms which follow are specifically defined for use herein. The term “ad survey” is used to refer to an advertisement (e.g. a product image and/or description) with an associated survey (e.g. a questionnaire regarding the product in the associated advertisement) for a user to complete. The terms “ad-survey incentive” and “ASI” are used to refer to any incentive awarded in recognition of a user completing an ad survey. Such an ASI can include, but is not limited to, a coupon, a point award, a mileage award, a discount, a redemption award, and an auction entry. It is noted that the term “advertiser” may refer also to entities that advertise on behalf of others, such as advertising agencies or companies that may create ads for publication on behalf of an advertiser and/or manage marketing campaigns on its behalf.

The term “click-through” option is used to refer to mechanism to that allows a user to pass from a current website to a related website (typically, by clicking a button). The term “opt-in” feature is used to refer to a mechanism that allows a user to indicate (typically, by clicking in a check box) his/her agreement to receive marketing information. With such an opt-in feature, agreement is only deemed to have been granted if such an explicit indication is provided. The term “opt-out” feature is used to refer to a mechanism that allows a user to explicitly indicate his/her disagreement to receive such marketing information. With such an opt-out feature, agreement is deemed to have been granted unless such explicit indication is provided.

Preferred embodiments of the present invention teach methods for on-line advertising which are interactive and non-intrusive, utilizing ad formats with extremely high conversion rates that can be priced using a performance-based model.

Preferred embodiments of the present invention provide a unique loyalty program with broad applicability and (optionally) white-labeling capabilities utilizing aspects of an on-line auction, helping publishers and advertisers bring people back again and again. Ad surveys can be designed using self-service web-based design tools. Ad surveys can support images and video, as well as multiple-choice or rating questions. A minimum response time for completing an ad survey can be used to increase exposure. Ad surveys can also encourage direct sales via a click-through option (into an advertiser's website) and opt-in/opt-out features (e.g. a user agreement to receive marketing information related to an ad survey). Ad surveys can also enable users to buy discounted products by using their ASI to reduce their cash purchase.

Therefore, according to the present invention, there is provided for the first time a method for interactive on-line advertising using auction prizes awarded based on user engagement as determined by ad-survey submission, the method including the steps of: (a) providing an ad survey having an advertisement and a survey for viewing and submission; (b) upon a user submitting a completed ad survey, presenting the user with an incentive to be pledged, by the user, to an ad-survey auction; and (c) awarding an auction prize to a winning user based on a maximum amount of pledged incentive in the ad-survey auction by the winning user.

Preferably, the method further includes the step of: (d) constructing a user profile having at least one user characteristic for users of the ad survey.

Most preferably, at least one user characteristic is selected from the group consisting of: a user surfing pattern, publicly-available user data, private user data, a user interest, and an ad-survey interest.

Preferably, the method further includes the step of: (d) constructing a publisher profile having at least one identifier for facilitating selection of the ad survey according to the user when the ad survey is submitted from a publisher site, wherein at least one identifier is selected from the group consisting of: a target-audience identifier, a preferred ad-survey-category identifier, and a prohibited ad-survey-category identifier.

Preferably, the method further includes the step of: (d) aggregating information associated with at least one item selected from the group consisting of: the ad survey, a publisher, the user, the ad-survey auction, the auction prize, the winning user, a bidding user, a related prize sponsor, and a related advertiser.

Preferably, the advertisement includes at least one item selected from the group consisting of: an image, a text segment, an audio segment, a video segment, and a multimedia segment.

Preferably, the survey includes at least one item selected from the group consisting of: a multiple-choice question, a poll, a questionnaire, a factual question requiring a correct response found in the advertisement, a rating, and a ranking.

Preferably, the ad survey includes at least one initiation point selected from the group consisting of: a banner ad, a webpage ad, a menu item, and a navigational object.

Preferably, the ad survey includes at least one feature selected from the group consisting of: a click-through option, a purchase option for a product related to the ad survey, a purchase option for a product related to an advertiser, a discount purchase option for purchasing using the incentive, a user agreement to receive marketing information related to the ad survey, an opt-in feature, and an opt-out feature.

Preferably, the step of presenting is contingent upon the completed ad survey being submitted after a minimum response time has elapsed.

Preferably, the step of presenting is contingent upon the completed ad survey being submitted with a correct response to a factual question.

Preferably, the step of awarding is determined by the maximum amount pledged within an auction constraint selected from the group consisting of: an auction elapsed-time limit, an auction allotted-time limit, a pledged-incentive limit, a user-participation limit, a minimum aggregate pledged-incentive limit for all bidding users, and an ad-survey user-engagement limit.

According to the present invention, there is provided for the first time a system for interactive on-line advertising using auction prizes awarded based on user engagement as determined by ad-survey submission, the method including: (a) an ad-survey module for providing at least one ad survey having a respective advertisement and a respective survey for viewing and submission; (b) a user-incentive module for, upon a user submitting a completed ad survey, presenting the user with an incentive to be pledged, by the user, to an ad-survey auction; and (c) an auction module for awarding an auction prize to a winning user based on a maximum amount of pledged incentive in the ad-survey auction by the winning user.

Preferably, the system further includes: (d) a user-profile module having at least one user characteristic for users of at least one ad survey.

Most preferably, at least one user characteristic is selected from the group consisting of: a user surfing pattern, publicly-available user data, private user data, a user interest, and an ad-survey interest.

Preferably, the system further includes: (d) a publisher-profile module having at least one identifier for facilitating selection of at least one ad survey according to the user when at least one ad survey is submitted from a publisher site, wherein at least one identifier is selected from the group consisting of: a target-audience identifier, a preferred ad-survey-category identifier, and a prohibited ad-survey-category identifier.

Preferably, the system further includes: (d) a response-statistics module for aggregating information associated with at least one item selected from the group consisting of: at least one ad survey, the user, a publisher, the ad-survey auction, the auction prize, the winning user, a bidding user, a related prize sponsor, and a related advertiser.

Preferably, the respective advertisement includes at least one item selected from the group consisting of: an image, a text segment an audio segment, a video segment, and a multimedia segment.

Preferably, the respective survey includes at least one item selected from the group consisting of: a multiple-choice question, a poll, and a questionnaire, a factual question requiring a correct response found in the respective advertisement, a rating, and a ranking.

Preferably, at least one ad survey includes at least one initiation point selected from the group consisting of: a banner ad, a webpage ad, a menu item, and a navigational object.

Preferably, at least one ad survey includes at least one feature selected from the group consisting of: a click-through option, a purchase option for a product related to at least one ad survey, a purchase option for a product related to an advertiser, a discount purchase option for purchasing using the incentive, a user agreement to receive marketing information related to at least one ad survey, an opt-in feature, and an opt-out feature.

Preferably, the user-incentive module is configured to present the incentive contingent upon the completed ad survey being submitted after a minimum response time has elapsed.

Preferably, the user-incentive module is configured to present the incentive contingent upon the completed ad survey being submitted with a correct response to a factual question.

Preferably, the auction module is configured to award the auction prize as determined by the maximum amount pledged within an auction constraint selected from the group consisting of: an auction elapsed-time limit, an auction allotted-time limit, a pledged-incentive limit, a user-participation limit, a minimum aggregate pledged-incentive limit for all bidding users, and an ad-survey user-engagement limit.

According to the present invention, there is provided for the first time a method of doing business system, the method including the steps of: (a) providing an ad-survey auction environment for: (i) providing at least one ad survey having an advertisement and a survey for viewing and submission; (ii) upon a user submitting a completed ad survey, presenting the user with an incentive to be pledged, by the user, to an ad-survey auction; and (iii) awarding an auction prize to a winning user based on a maximum amount of pledged incentive in the ad-survey auction by the winning user; and (b) offering at least one ad survey for sale.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A is a simplified schematic block diagram of a system configuration for enabling interactive on-line advertising using auction prizes awarded based on user engagement as determined by ad-survey submission, according to preferred embodiments of the present invention;

FIG. 1B is a simplified schematic block diagram of an alternate system configuration for enabling interactive on-line advertising using auction prizes awarded based on user engagement as determined by ad-survey submission, according to preferred embodiments of the present invention;

FIG. 2 is a simplified schematic block diagram of the system configuration of the system of FIG. 1A showing the component interconnections and their process flow steps, according to preferred embodiments of the present invention;

FIG. 3 is a simplified flowchart of the major process steps for interactive on-line advertising using auction prizes awarded based on user engagement as determined by ad-survey submission for the system of FIG. 2, according to preferred embodiments of the present invention.

### DESCRIPTION OF THE PREFERRED EMBODIMENTS

The present invention relates to systems and methods for interactive on-line advertising using auction prizes awarded based on user engagement as determined by ad-survey submission. The principles and operation for such systems and methods, according to the present invention, may be better understood with reference to the accompanying description and the drawings.

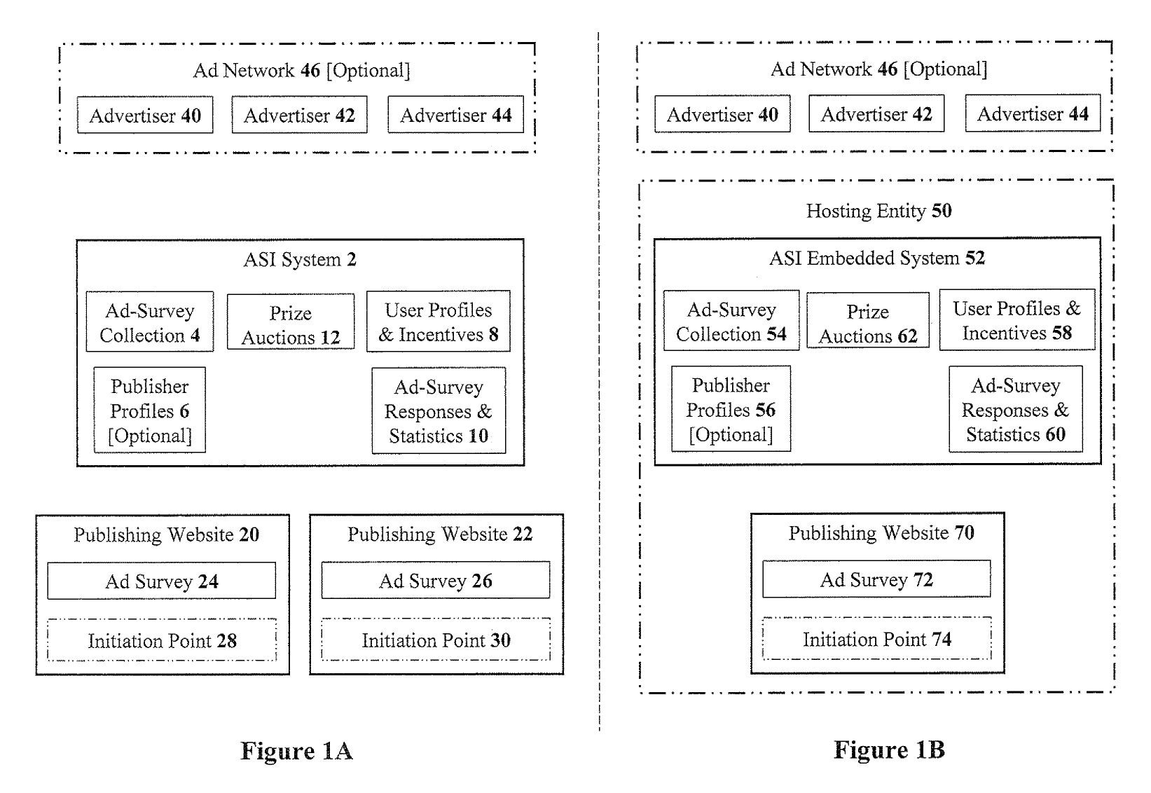

Referring now to the drawings, FIG. 1A is a simplified schematic block diagram of a system configuration for enabling interactive on-line advertising using auction prizes awarded based on user engagement as determined by ad-survey submission, according to preferred embodiments of the present invention. An ad-survey incentive (ASI) system 2 (e.g. a web-service system or site) maintains a set of ad surveys in an ad-survey collection 4. The ad surveys in ad-survey collection 4 can optionally be associated with publisher profiles 6 for matching ad surveys according to the target audience of the publishers. User profiles & incentives 8 maintains information about users and the ASIs that they have accumulated. User profiles can also provide useful information to the ASI System, advertisers, and ad networks (e.g. by tracking a user's surfing pattern, determining a user's interests, and/or determining which types of ad surveys interest a user). Ad-survey responses & statistics 10 aggregates information about ad surveys presented to each user, completed ad surveys, and the users' profiles to generate response statistics. Prize auctions 12 maintains the prizes associated with one or more ad-survey auctions, and the users who are bidding on the prizes.

As an exemplary scenario, in order to provide an incentive for consuming advertisements, publishing websites 20 and 22 (e.g. on-line publishers) independently offer to visitors an ASI for each ad survey (e.g. ad surveys 24 and 26) that is submitted on their site. Users can be presented the opportunity to complete ad surveys 24 and 26 in various forms (e.g. banner ad, menu item, or navigational object) through initiation points 28 and 30.

Ad surveys 24 and 26 are paid for by advertisers 40-44. Advertisers 40-44 may optionally be advertising through an ad network 46. Prize auctions 12 can include products offered by ASI system 2 in various formats (e.g. a high-bid auction or a time-limited auction). It is noted that the viewing of the prizes (e.g. images/descriptions) from prize auctions 12 is also a form of advertising. Such prizes can be paid for by advertisers 40-44. Advertisers 40-44 may optionally be advertising such prizes through ad network 46. Ad surveys can support images and video, as well as multiple-choice or rating questions. A minimum response time for completing an ad survey can be used to increase exposure. Ad surveys can also encourage direct sales via “click-through” and “opt-in” features. Ad surveys can also enable users to buy discounted products by using their ASI to reduce their cash purchase.

FIG. 1B is a simplified schematic block diagram of an alternate system configuration for enabling interactive on-line advertising using auction prizes awarded based on user engagement as determined by ad-survey submission, according to preferred embodiments of the present invention. A hosting entity 50 (e.g. a publishing website or portal) maintains an ASI embedded system 52. ASI embedded system 52 has an ad-survey collection 54, optional publisher profiles 56, user profiles & incentives 58, ad-survey responses & statistics 60, and prize auctions 62 similar to those components described in FIG. 1A. A publishing website 70 having an ad survey 72 and an initiation point 74 is also shown within the domain of hosting entity 50. Publishers who are affiliated with publishing website 70 can be hosted in the same environment as publishing website 70. Publishers who are not affiliated with publishing website 70 can benefit from the use of optional publisher profiles 56.

The implementation of FIGS. 1A-B may be a software or hardware implementation. One of the main features of the implementation of FIG. 1B is that hosting entity 50 controls how ASI embedded system 52 is configured and administered. In practice, hosting entity 50 may be publishing website 70. In such a configuration, external publishers (e.g. publishing websites 20 and 22) cannot utilize ASI embedded system 52 independently to offer ad-survey auctions.

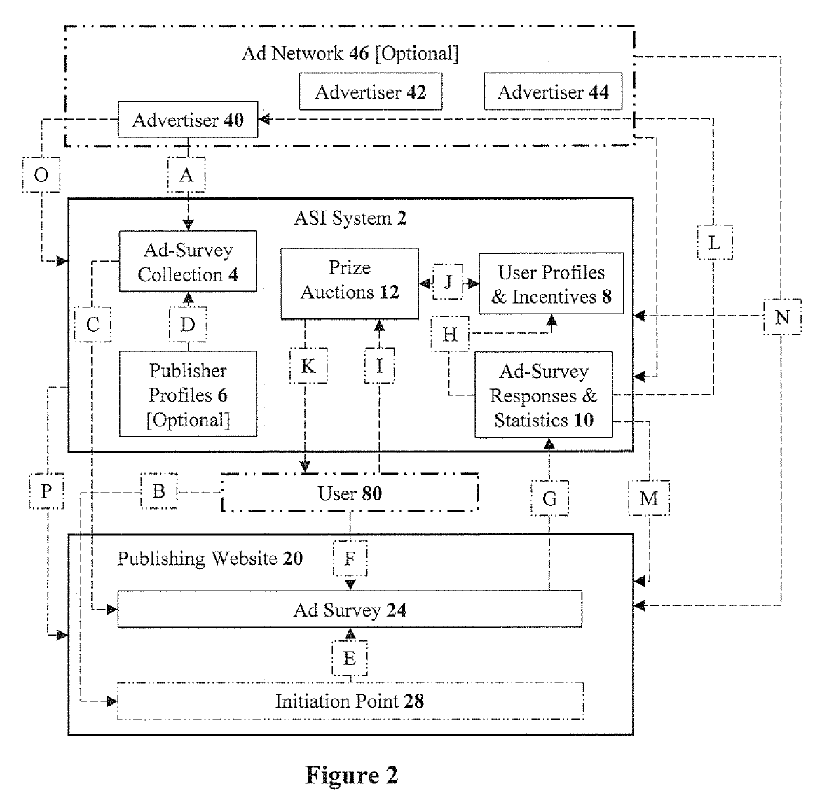

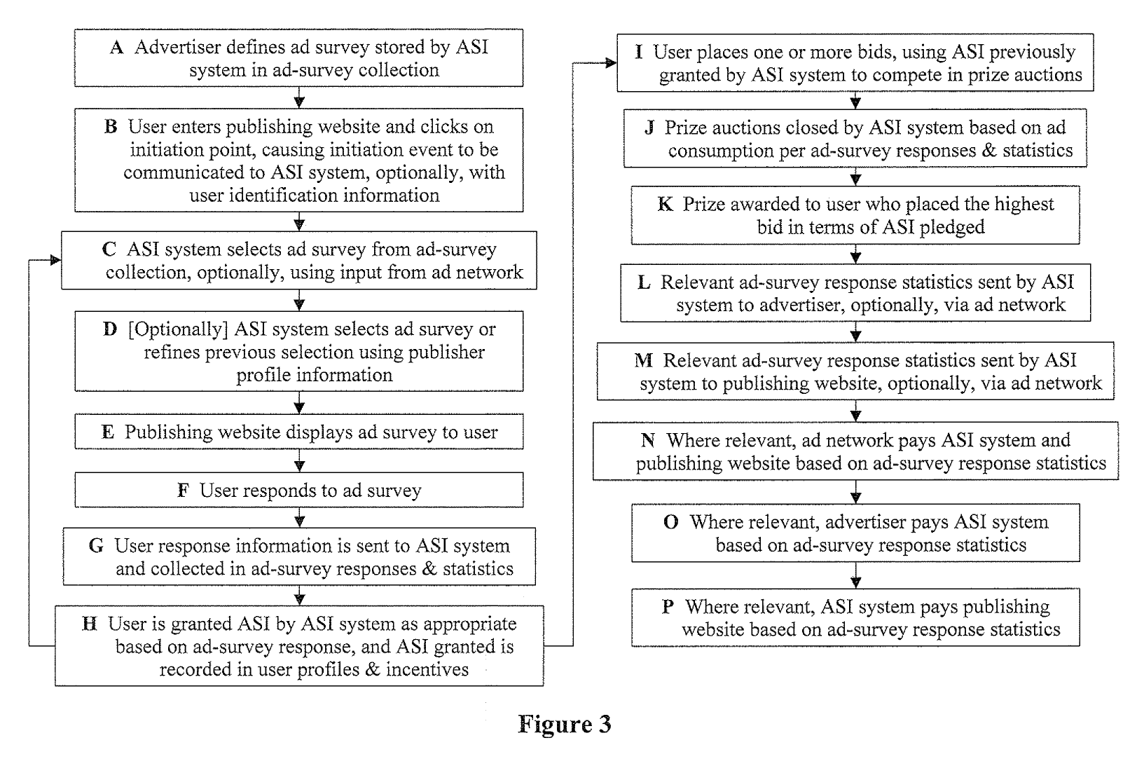

FIG. 2 is a simplified schematic block diagram of the system configuration of the system of FIG. 1A showing the component interconnections and their process flow steps, according to preferred embodiments of the present invention. A user 80 is shown to depict how ASI system 2 and its components interact with user 80 and with the other components. Process steps A-P are described below in regard to FIG. 3.

It is understood that in the exemplary embodiments of FIGS. 1-2, the number and types of advertisements, ad surveys, advertisers, publishing websites, ad networks, prizes, and users can be modified during implementation.

FIG. 3 is a simplified flowchart of the major process steps for interactive on-line advertising using auction prizes awarded based on user engagement as determined by ad-survey submission for the system of FIG. 2, according to preferred embodiments of the present invention. The process starts with an advertiser defining an ad survey stored by ASI system in the ad-survey collection (Step A). When a user enters a publishing website, and clicks on an initiation point, causing initiation event to be communicated to ASI system, optionally, with user identification information (Step B), the ASI system selects an ad survey from ad-survey collection, optionally, using input from an ad network (Step C). Optionally, the ASI system can select the ad survey or refine a previous selection using information from the publisher's profile (Step D). Using the publisher's profile can facilitate better ad-survey placement when an ad network is not involved. Publishing website then displays the ad survey to the user (Step E).

The user can then respond to the ad survey (Step F). The user may also choose to skip the particular ad survey, and complete another one instead. The user's response information is sent to the ASI system, and collected in ad-survey responses & statistics (Step G). The user is granted ASI by the ASI system as appropriate based on the ad-survey response, and the ASI granted is recorded in the user's profile & incentives (Step H). It is noted that Steps C-H may occur multiple times prior to reaching Step I.

The user can place one or more bids using ASI previously granted by the ASI system to compete in the prize auctions (Step I). Prize auctions are closed by the ASI system based on ad consumption according to ad-survey responses & statistics (Step J). Prizes are awarded to users who placed the highest bids in terms of ASI pledged (Step K). The relevant ad-survey response statistics can be sent by the ASI system to the advertisers, optionally, via an ad network (Step L). The relevant ad-survey response statistics can also be sent by the ASI system to the publishing website, optionally, via an ad network (Step M).

Where relevant, the ad network pays the ASI system and publishing website based on the ad-survey response statistics (Step N). Where relevant, the advertiser pays the ASI system based on the ad-survey response statistics (Step O). Where relevant, the ASI system pays the publishing website based on the ad-survey response statistics (Step P).

It is noted that multiple advertisers may create ad surveys, and pay for their results. They may do so as customers of an ad network, as customers of the ASI system, or even as customers of one or more publishing websites (as long as these publishing websites have licensed an ASI embedded system implementation as described with regard to FIG. 1B). Furthermore, in some preferred embodiments, users can accumulate ASI by responding to ad surveys on multiple unrelated publishing websites when utilizing systems configured as in FIG. 1A. Users accumulate incentives only within the context of a specific hosting entity (e.g. publishing website or portal) who has licensed the ASI embedded system implementation in which their profiles are managed as in FIG. 1B.

While the invention has been described with respect to a limited number of embodiments, it will be appreciated that many variations, modifications, and other applications of the invention may be made.

What is claimed is:

1. A method for interactive on-line advertising using auction prizes awarded based on user engagement as determined by ad-survey submission, the method comprising the steps of:
(a) providing an ad survey having an advertisement and a survey for viewing and submission;
(b) upon a user submitting a completed ad survey, presenting said user with an incentive to be pledged, by said user, to an ad-survey auction; and
(c) awarding an auction prize to a winning user based on a maximum amount of pledged incentive in said ad-survey auction by said winning user.

2. The method of claim 1, the method further comprising the step of:
(d) constructing a user profile having at least one user characteristic for users of said ad survey.

3. The method of claim 2, wherein said at least one user characteristic is selected from the group consisting of: a user surfing pattern, publicly-available user data, private user data, a user interest, and an ad-survey interest.

4. The method of claim 1, the method further comprising the step of:
(d) constructing a publisher profile having at least one identifier for facilitating selection of said ad survey according to said user when said ad survey is submitted from a publisher site, wherein said at least one identifier is selected from the group consisting of: a target-audience identifier, a preferred ad-survey-category identifier, and a prohibited ad-survey-category identifier.

5. The method of claim 1, the method further comprising the step of:
(d) aggregating information associated with at least one item selected from the group consisting of: said ad survey, a publisher, said user, said ad-survey auction, said auction prize, said winning user, a bidding user, a related prize sponsor, and a related advertiser.

6. The method of claim 1, wherein said advertisement includes at least one item selected from the group consisting of: an image, a text segment, an audio segment, a video segment, and a multimedia segment.

7. The method of claim 1, wherein said survey includes at least one item selected from the group consisting of: a multiple-choice question, a poll, a questionnaire, a factual question requiring a correct response found in said advertisement, a rating, and a ranking.

8. The method of claim 1, wherein said ad survey includes at least one initiation point selected from the group consisting of: a banner ad, a webpage ad, a menu item, and a navigational object.

9. The method of claim 1, wherein said ad survey includes at least one feature selected from the group consisting of: a click-through option, a purchase option for a product related to said ad survey, a purchase option for a product related to an advertiser, a discount purchase option for purchasing using said incentive, a user agreement to receive marketing information related to said ad survey, an opt-in feature, and an opt-out feature.

10. The method of claim 1, wherein said step of presenting is contingent upon said completed ad survey being submitted after a minimum response time has elapsed.

11. The method of claim 1, wherein said step of presenting is contingent upon said completed ad survey being submitted with a correct response to a factual question.

12. The method of claim 1, wherein said step of awarding is determined by said maximum amount pledged within an auction constraint selected from the group consisting of: an auction elapsed-time limit, an auction allotted-time limit, a pledged-incentive limit, a user-participation limit, a minimum aggregate pledged-incentive limit for all bidding users, and an ad-survey user-engagement limit.

13. A system for interactive on-line advertising using auction prizes awarded based on user engagement as determined by ad-survey submission, the system comprising:
(a) an ad-survey module for providing at least one ad survey having a respective advertisement and a respective survey for viewing and submission;
(b) a user-incentive module for, upon a user submitting a completed ad survey, presenting said user with an incentive to be pledged, by said user, to an ad-survey auction; and
(c) an auction module for awarding an auction prize to a winning user based on a maximum amount of pledged incentive in said ad-survey auction by said winning user.

14. The system of claim 13, the system further comprising:
(d) a user-profile module having at least one user characteristic for users of said at least one ad survey.

15. The system of claim 14, wherein said at least one user characteristic is selected from the group consisting of: a user surfing pattern, publicly-available user data, private user data, a user interest, and an ad-survey interest.

16. The system of claim 13, the system further comprising:
(d) a publisher-profile module having at least one identifier for facilitating selection of said at least one ad survey according to said user when said at least one ad survey is submitted from a publisher site, wherein said at least one identifier is selected from the group consisting of: a target-audience identifier, a preferred ad-survey-category identifier, and a prohibited ad-survey-category identifier.

17. The system of claim 13, the system further comprising:
(d) a response-statistics module for aggregating information associated with at least one item selected from the group consisting of: said at least one ad survey, said user, a publisher, said ad-survey auction, said auction prize, said winning user, a bidding user, a related prize sponsor, and a related advertiser.

18. The system of claim 13, wherein said respective advertisement includes at least one item selected from the group consisting of: an image, a text segment, an audio segment, a video segment, and a multimedia segment.

19. The system of claim 13, wherein said respective survey includes at least one item selected from the group consisting of: a multiple-choice question, a poll, and a questionnaire, a factual question requiring a correct response found in said respective advertisement, a rating, and a ranking.

20. The system of claim 13, wherein said at least one ad survey includes at least one initiation point selected from the group consisting of: a banner ad, a webpage ad, a menu item, and a navigational object.

21. The system of claim 13, wherein said at least one ad survey includes at least one feature selected from the group consisting of: a click-through option, a purchase option for a product related to said at least one ad survey, a purchase option for a product related to an advertiser, a discount purchase option for purchasing using said incentive, a user agreement to receive marketing information related to said at least one ad survey, an opt-in feature, and an opt-out feature.

22. The system of claim 13, wherein said user-incentive module is configured to present said incentive contingent upon said completed ad survey being submitted after a minimum response time has elapsed.

23. The system of claim 13, said user-incentive module is configured to present said incentive contingent upon said completed ad survey being submitted with a correct response to a factual question.

24. The system of claim 13, wherein said auction module is configured to award said auction prize as determined by said maximum amount pledged within an auction constraint selected from the group consisting of: an auction elapsed-time limit, an auction allotted-time limit, a pledged-incentive limit, a user-participation limit, a minimum aggregate pledged-incentive limit for all bidding users, and an ad-survey user-engagement limit.

25. A method of doing business, the method comprising the steps of:
(a) providing an ad-survey auction environment for:
(i) providing at least one ad survey having an advertisement and a survey for viewing and submission;
(ii) upon a user submitting a completed ad survey, presenting said user with an incentive to be pledged, by said user, to an ad-survey auction; and
(iii) awarding an auction prize to a winning user based on a maximum amount of pledged incentive in said ad-survey auction by said winning user; and
(b) offering said at least one ad survey for sale.
